(19) United States
(12) Patent Application Publication
(10) Pub. No.: US 2024/0294850 A1
(43) Pub. Date: Sep. 5, 2024

(54) COLOR CHANGING CLEANING COMPOSITIONS

(71) Applicant: Energizer Auto, Inc., St. Louis, MO (US)

(72) Inventors: Christopher Stacey, Cleveland, OH (US); James Aschenbener, Brooklyn, OH (US)

(73) Assignee: Energizer Auto, Inc., St. Louis, MO (US)

(21) Appl. No.: 18/594,883

(22) Filed: Mar. 4, 2024

Related U.S. Application Data
(60) Provisional application No. 63/488,406, filed on Mar. 3, 2023.

(51) Int. Cl. C11D 3/34; C11D 3/43; C11D 3/48

(52) U.S. Cl. CPC C11D 3/3481; C11D 3/43; C11D 3/48; C11D 2111/14

(57) ABSTRACT

The present disclosure describes compositions, methods of making the compositions, and methods of using the compositions to clean the surfaces of wheels and tires and painted surfaces, for example of a vehicle. The compositions include one or more metal removers, one or more cleaner enhancers; and one or more cleaners, wherein the composition changes color after being applied to a surface to remove one or more metals. The compositions can further include one or more chelating agents, one or more antimicrobials, and/or one or more solvents.

### CROSS REFERENCE TO RELATED APPLICATIONS

The present application claims the benefit of U.S. Provisional Patent Application No. 63/488,406 filed Mar. 3, 2023, which is incorporated herein by reference in its entirety.

### TECHNICAL FIELD

The present disclosure describes compositions and methods for cleaning wheels and tires.

### BACKGROUND

Effective wheel, tire, and painted surface cleaners are difficult to develop. Oil, grease, dirt, salt, and other environmental contaminants may become coated on wheels, tires, and painted surfaces of vehicles during normal use. Products have been developed to clean these contaminants from vehicle surfaces; however, metallic contaminants (e.g. iron, carbon, rust) and brake dust that accumulate on wheels, tires, and painted surfaces near vehicle brake pads are not able to be cleaned by traditional products. Additionally, metallic contaminants and brake dust may become combined with oil, grease, dirt, salt, and other environmental contaminants which makes cleaning uniquely difficult.

Metallic contaminants and brake dust may come from a few sources including rotors and brake pads as the outer surface of the rotor and brake pads are worn down by the friction of breaking. Brake rotors (or discs) are commonly made from cast iron, and most modern brake pads are made of a ceramic material that's impregnated with iron. A “ceramic” brake pad can be made up of as much as 30% iron. Steel, copper, iron, and several alloys with durable and heat-resistant qualities are also used in the production of brake pads. When brake pads are used, friction on the brake pad and rotor creates iron dust, carbon residue, and iron particles which collect on rims, wheels, tires, and painted surfaces of vehicles. A build-up of brake dust and grime can cause problems over time if it's not cleaned properly. This buildup can eventually corrode the protective coating on wheels and rims which may lead to permanent damage. Brake dust may also damage the painted surfaces of vehicles. The iron dust, carbon residue, and iron particles include jagged metal fragments that can wear away paint if it is not cleaned from these surfaces properly. This may lead to damage to a painted surface's coatings and can eventually expose the vehicle body to rust.

Metallic contaminants and brake dust pose a difficult cleaning task for consumers. Because of the potential damage that may result from improper cleaning, there is a need for a specialized cleaning formula that addresses metallic contaminants, specifically iron, and brake dust for vehicle wheels, tires, and painted surfaces.

### SUMMARY

This Summary is provided to introduce a selection of concepts in a simplified form that is further described below in the Detailed Description. This Summary is not intended to identify all key features or essential features of the claimed subject matter, nor is it intended to be used alone as an aid in determining the scope of the claimed subject matter.

The present disclosure describes compositions for cleaning wheels, tires, and painted surfaces, for example of a vehicle.

The compositions described herein include one or more metal removers, one or more cleaner enhancers, and one or more cleaners. The compositions change color when applied to a surface. The one or more metal removers comprise a catalyst, such as ammonium thioglycolate, that enables the change in color of the composition. In embodiments, the one or more metal removers, such as ammonium thioglycolate, remove iron. Optionally, the compositions can further include one or more chelating agents, one or more antimicrobial agents, and one or more solvents.

In embodiments, the compositions described herein include by weight percent (wt %) of the total composition:
about 55 wt % to about 75 wt % of water;
about 0.01 wt % to about 1.0 wt % of benzisothiazolinone or a mixture of benzisothiazol-3(2h)-one, 5-chloro-2-methyl-4-isothiazolin-3-one, and 2-methyl-2H-isothiazol-3-one;
about 0.1 wt % to about 5.0 wt % of tetrasodium ethylenediamine tetraacetate;
about 5 wt % to about 25 wt % of ammonium thioglycolate;
about 5 wt % to about 15 wt % of diethylene glycol monobutyl ether;
about 1 wt % to about 10 wt % of cocamidopropyl betaine; and
about 1 wt % to about 10 wt % of sodium C14-16 olefin sulfonate.

The present disclosure also describes methods of preparing the composition and methods of using the compositions to clean wheels, tires, and painted surfaces, especially those of a vehicle.

### DETAILED DESCRIPTION

The present disclosure describes cleaning compositions that include components that interact to clean a surface and while cleaning, the color of the composition changes indicating that the composition is performing its function of cleaning. The compositions described herein include one or more metal removers, one or more cleaner enhancers, and one or more cleaners.

The one or more metal removers of the compositions described herein include one or more catalysts that trap and remove metals and change the color of the composition when the metal is being removed. The one or more catalysts remove the metal contaminants in contact with the composition by dissolving the metal. The metal can be iron, copper, steel, alloy, and/or other metals. In embodiments, the catalyst is ammonium thioglycolate and the metal to be removed is iron.

The compositions described herein can further include one or more chelating agents for removing the metal. Chelating agents are sequestering agents or molecules capable of forming complexes with metal ions. In cleaning products, they are most commonly used to prevent soaps/detergents from reacting with the mineral deposits in hard water and forming soap scum. The mechanism by which chelating agents work is by combining with certain metal ions to form a molecular complex that locks up or chelates the metal ion so that it no longer exhibits ionic properties. The one or more chelating agents can also assist in removing metals while cleaning the surface.

Examples of chelating agents include tetrasodium ethylenediamine tetraacetate, tetrasodium glutamate diacetate; compound L-glutamic acid, N,N-diacetic acid, tetrasodium salt (GLDA); and thioglycolic acid (TGA) and its salts such as ammonium thioglycolate and potassium thiogycolate. In embodiments, the one or more chelating agents include tetrasodium ethylenediaminetetraacetate (for example, VERSENE™ 100).

The one or more cleaner enhancers of the compositions described herein include an organic solvent, such as diethylene glycol monobutyl ether (for example Butyl CARBITOL™).

The one or more cleaners of the compositions described herein include one or more surfactants such as one or more anionic or amphoteric surfactants. Surfactant is a surface-active agent that is a basic building block of all cleaning products. Surfactants alter the properties of water to enable it to clean. They lower the surface tension of water (makes water wetter). They also make water and oils compatible with each other through a process called emulsification. Anionic surfactants are surfactants that carry a negatively charged head group. Amphoteric surfactants are surfactants with both acidic and alkaline properties. Amphoteric surfactants have a dual charge on their hydrophilic end, both positive and negative. The dual charges cancel each other out creating a net charge of zero, referred to as zwitterionic. The pH of any given solution determines how the amphoteric surfactants work.

Examples of anionic surfactants include an alkali metal salt or an ammonium salt. In embodiments, the alkali metal salt is selected from the group sodium C8-22 alkyl sulfate, potassium C8-22 alkyl sulfate, ammonium C8-22 alkyl sulfate, sodium C8-22 alkyl benzene sulfate, potassium C8-22 alkyl benzene sulfate, ammonium C8-22 alkyl benzene sulfate, sodium lauryl sulfate, sodium C8-22 alkyloyl sarcosinate, and an α-olefin sulfonate of the formula

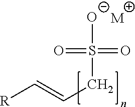

wherein R is an C8-22 alkyl group, M⁺ is Na⁺ or K⁺ and n is 1 or 2.

In embodiments, the one or more anionic surfactants include one or more metal olefin sulfonates such as sodium C14-16 olefin sulfonate (for example, Calsoft® AOS-40).

Examples of amphoteric surfactants include betaines. Betaines are characterized by a fully quaternized nitrogen atom and do not exhibit anionic properties in alkaline solutions, which means that betaines are present only as zwitterions. In embodiments, the betaine is an alkyl betaine of the formula

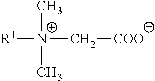

wherein R¹ is a C₆-C₂₂ alkyl group; or an alkylamidopropyl betaine of the formula

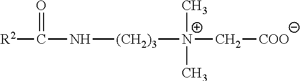

wherein R² is a C₆-C₂₂ alkyl group. A specific example of an alkylamidopropyl betaine is cocamidopropyl betaine (cocoamidopropyl betaine), having the structure:

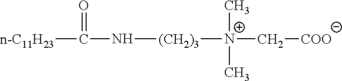

In embodiments, the one or more amphoteric surfactants of the compositions described herein include cocamidopropyl betaine (for example, Caltaine® C-35).

The compositions described herein can further include one or more antimicrobial agents and the antimicrobial agents can also act as preservatives. An example of an antimicrobial agent that is also a preservative is benzisothiazolinone (for example, TROYGUARD™ BC11).

The compositions described herein can further include one or more solvents in the form of a carrier such as water. The water can be deionized (DI) water and/or reverse osmosis (RO) water.

In embodiments, the compositions described herein include one or more solvents, one or more antimicrobial agents, one or more chelating agents, one or more metal removers, one or more cleaner enhancers, and one or more cleaners, and optionally at least two cleaners.

In embodiments, the compositions include by weight percent (wt %) of the total composition:
about 55.0 wt % to 75.0 wt %, about 57.0 wt % to 72.0 wt %, about 60.0 wt % to 70.0 wt %, about 62.0 wt % to 68.0 wt %, about 64.0 wt % to 66.5 wt %, about 65.0 wt %, or about 65.9 wt % of water;
about 0.01 wt % to 1.0 wt %, 0.05 wt % to 0.5 wt %, about 0.07 wt % to 0.3 wt %, about 0.08 wt % to 0.2 wt %, or about 0.1 wt % of benzisothiazolinone;
about 0.1 wt % to 5.0 wt %, about 0.1 wt % to 3.0 wt %, about 0.1 wt % to 1.0 wt %, about 0.2 wt % to 0.8 wt %, 0.3 wt % to 0.7 wt %, about 0.4 wt % to 0.6 wt %, or about 0.5 wt % of tetrasodium ethylenediamine tetraacetate;
about 5 wt % to about 25 wt %, about 7 wt % to 20 wt %, about 10 wt % to 17 wt %, 10 wt % to 15 wt %, about 12 wt % to 14 wt %, or about 13.5 wt % of ammonium thioglycolate;
about 5 wt % to about 15 wt %, about 7 wt % to 13 wt %, about 8 wt % to 12 wt %, about 9 wt % to 11 wt %, or about 10 wt % of diethylene glycol monobutyl ether;
about 1 wt % to about 10 wt %, about 2 wt % to 8 wt %, about 4 wt % to 6 wt %, or about 5 wt % of cocamidopropyl betaine; and
about 1 wt % to about 10 wt %, about 2 wt % to 8 wt %, about 4 wt % to 6 wt %, or about 5 wt % of sodium C14-16 olefin sulfonate.

In embodiments, the compositions described herein include by weight percent (wt %) of the total composition:
about 65.9 wt % of deionized water and/or reverse osmosis water;
about 0.1 wt % of benzisothiazolinone or TROYGUARD™ BC11;
about 0.5 wt % of tetrasodium ethylenediamine tetraacetate or VERSENE™ 100;
about 13.5 wt % of ammonium thioglycolate or ammonium thioglycolate (ca. 60% in water);
about 10 wt % of diethylene glycol monobutyl ether or Butyl CARBITOL™;
about 5 wt % of cocamidopropyl betaine or Caltaine® C-35; and
about 5 wt % of sodium C14-16 olefin sulfonate or Calsoft® AOS-40.

In embodiments, each of the components of the compositions described herein can be a mixture including the main ingredient and one or more other ingredients. For example, TROYGUARD™ BC11, an example of benzisothiazolinone, can include benzisothiazol-3(2h)-one as the main ingredient, and 5-chloro-2-methyl-4-isothiazolin-3-one and 2-methyl-2H-isothiazol-3-one. VERSENE™ 100, an example of tetrasodium ethylenediamine tetraacetate, can include tetrasodium ethylenediamine tetraacetate as the main ingredient and water, sodium hydroxyacetate, sodium hydroxide, and trisodium nitrilotriacetate. Ammonium thioglycolate (ca 60% in water), an example of ammonium thioglycolate, can include ammonium thioglycolate (60%) and water (40%). Butyl CARBITOL™, an example of diethylene glycol monobutyl ether, can include diethylene glycol monobutyl ether. Caltaine® C-35, an example of cocamidopropyl betaine, can include 1-propanaminium, 3-amino-n-(carboxymethyl)-n,n-dimethyl-, N-coco acyl derivs., inner salts; 1,2,3-propanotriol; and citric acid. Calsoft® AOS-40, an example of sodium C14-16 olefin sulfonate, can include sulfonic acids, C14-16-alkane hydroxy and C14-16-alkene, sodium salts, and other ingredients. The other ingredients in each component can also include amounts of ingredients that are below reportable levels. The other ingredients can also include small amounts of impurities.

The present disclosure also describes methods of preparing the compositions described herein. The methods include adding each component of the composition sequentially or adding all components of the composition at the same time to a container and mixing. The methods also include adding the components sequentially with constant mixing, as each of the components is added. The prepared composition can be dispensed in a trigger spray bottle.

Moreover, the present disclosure describes methods of using the compositions described herein to clean surfaces including wheels, tires, and painted surfaces. The painted surfaces include the surfaces of a vehicle. The methods described herein include applying a composition described herein to a surface, allowing the composition to remain on the surface until the color of the composition changes, and wiping the surface. The composition can be applied and/or wiped with cloth, paper towel, sponge, or a combination thereof. The methods described herein can further include rinsing the surface, and/or drying the surface.

Examples of vehicles include automobiles, buses, trains, watercraft including ships and boats, aircraft including planes and helicopters, and spacecraft.

The terms “composition(s)” and “formulation(s)” are used interchangeably to refer to the compositions described herein.

As will be understood by one of ordinary skill in the art, each embodiment disclosed herein can comprise, consist essentially of, or consist of its particular stated element, step, ingredient, or component. Thus, the terms “include” or “including” should be interpreted to recite: “comprise, consist of, or consist essentially of.” As used herein, the transition term “comprise” or “comprises” means includes, but is not limited to, and allows for the inclusion of unspecified elements, steps, ingredients, or components, even in major amounts. The transitional phrase “consisting of” excludes any element, step, ingredient, or component not specified. The transition phrase “consisting essentially of” limits the scope of the embodiment to the specified elements, steps, ingredients, or components and to those that do not materially affect the embodiment. As used herein, a material effect would cause a statistically significant difference in the performance of the composition in cleaning a surface.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the disclosure and does not pose a limitation on the scope of the disclosure otherwise claimed. No language in the specification should be construed as indicating any non-claimed element essential to the practice of the disclosure.

Groupings of alternative elements or embodiments of the disclosure disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this disclosure are described herein, including the best mode known to the inventors for carrying out the disclosure. Of course, variations on these described embodiments will become apparent to those of ordinary skill in the art upon reading the foregoing description. The inventor expects skilled artisans to employ such variations as appropriate, and the inventors intend for the disclosure to be practiced otherwise than specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

Furthermore, numerous references have been made to patents, printed publications, journal articles, and other written text throughout this specification (referenced materials herein). Each of the referenced materials is individually incorporated herein by reference in their entirety for their referenced teaching.

It is to be understood that the embodiments of the disclosure disclosed herein are illustrative of the principles of the present disclosure. Other modifications that may be employed are within the scope of the disclosure. Thus, by way of example, but not of limitation, alternative configurations of the present disclosure may be utilized following the teachings herein. Accordingly, the present disclosure is not limited to that precisely as shown and described.

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings and/or examples making apparent to those skilled in the art how the several forms of the disclosure may be embodied in practice.

The present disclosure is further described by reference to the following exemplary embodiments and examples. These exemplary embodiments and examples are provided for purposes of illustration only and are not intended to be limiting unless otherwise specified. Thus, the present disclosure should in no way be construed as being limited to the following exemplary embodiments and examples, but rather, should be construed to encompass any and all variations which become evident as a result of the teaching provided herein.

### Exemplary Embodiments

1. A composition including:
   one or more metal removers;
   one or more cleaner enhancers; and
   one or more cleaners
wherein the composition changes color when applied to a surface to remove metal, and optionally wherein the metal includes iron, copper, steel, and/or alloys.
2. The composition of embodiment 1, wherein the composition further includes one or more chelating agents.
3. The composition of embodiment 1 or 2, wherein the composition further includes one or more antimicrobial agents, and optionally the one or more antimicrobials include one or more preservatives.
4. The composition of any one of embodiments 1-3, wherein the composition further includes one or more solvents, and optionally, wherein the one or more solvents include a carrier.
5. The composition of any one of embodiments 1-4, wherein the composition includes one or more solvents, one or more antimicrobial agents, one or more chelating agents, one or more metal removers, one or more cleaner enhancers, and one or more cleaners, and optionally at least two cleaners.
6. The composition of any one of embodiments 1-5, wherein the one or more cleaners include surfactants, and optionally the one or more surfactants include anionic surfactants and/or amphoteric surfactants.
7. The composition of embodiment 6, wherein the one or more surfactants include betaines and/or metal olefin sulfonates.
8. The composition of embodiment 6 or 7, wherein the one or more surfactants include cocamidopropyl betaine.
9. The composition of any one of embodiments 6-8, wherein the one or more surfactants include sodium C14-16 olefin sulfonate.
10. The composition of any one of embodiments 1-9, wherein the one or more cleaners include cocamidopropyl betaine and sodium C14-16 olefin sulfonate.
11. The composition of any one of embodiments 1-10, wherein the one or more metal removers include a catalyst, which causes the composition to change color.
12. The composition of any one of embodiments 1-11, wherein the one or more metal removers include ammonium thioglycolate.
13. The composition of any one of embodiments 1-12, wherein one or more cleaner enhancers include an organic solvent.
14. The composition of any one of embodiments 1-13, wherein the one or more cleaners include diethylene glycol monobutyl ether.
15. The composition of any one of embodiments 1-14, wherein the one or more chelating agents include tetrasodium ethylenediamine tetraacetate.
16. The composition of any one of embodiments 1-15, wherein the one or more antimicrobial agents include a preservative.
17. The composition of embodiment 16, wherein the one or more antimicrobial agents include benzisothiazolinone, optionally the one or more antimicrobial agents include a mixture of benzisothiazol-3(2h)-one, 5-chloro-2-methyl-4-siothiazolin-3-one, and 2-methyl-2H-isothiazol-3-one.
18. The composition of any one of embodiments 1-17, wherein the solvent includes deionized water.
19. The composition of any one of embodiments 1-18, wherein the composition includes by weight percent (wt %) of the total composition:
   about 55 wt % to about 75 wt % of water or DI and/o RO water;
   about 0.01 wt % to about 1.0 wt % of benzisothiazolinone;
   about 0.1 wt % to about 5.0 wt % of tetrasodium ethylenediamine tetraacetate;
   about 5 wt % to about 25 wt % of ammonium thioglycolate;
   about 5 wt % to about 15 wt % of diethylene glycol monobutyl ether;
   about 1 wt % to about 10 wt % of cocamidopropyl betaine; and
   about 1 wt % to about 10 wt % of sodium C14-16 olefin sulfonate.
20. The composition of any one of embodiments 1-19, wherein the composition includes by weight percent (wt %) of the total composition:
   about 65.9 wt % of DI and/or RO water;
   about 0.1 wt % of benzisothiazolinone, and optionally TROYGUARD™ BC11;
   about 0.5 wt % of tetrasodium ethylenediamine tetraacetate, and optionally VERSENE™ 100;
   about 13.5 wt % of ammonium thioglycolate, and optionally ammonium thioglycolate (ca. 60% in water);
   about 10 wt % of diethylene glycol monobutyl ether, and optionally Butyl CARBITOL™;
   about 5 wt % of cocamidopropyl betaine, and optionally Caltaine® C-35; and
   about 5 wt % of sodium C14-16 olefin sulfonate, and optionally Calsoft® AOS-40.
21. A method of cleaning, wherein the method includes applying the composition of any one of embodiments 1-20 to a surface, allowing the composition to remain on the surface until the color of the composition changes, and wiping the surface.
22. The method of embodiment 21, wherein the method further comprises rinsing the surface, and/or drying the surface.
23. The method of embodiment 21 or 22, wherein the composition is applied to the surface and/or the surface is wiped and/or dried using a cloth, a paper towel, a sponge, or a combination thereof.
24. The method of one of the embodiments 21-23, wherein the surface includes the surface of a wheel or tire.
25. The method of any one of embodiments 21-24, wherein the surface includes a painted surface of a vehicle.
26. The method of any one of embodiments 21-25, wherein the method removes one or more metals from the surface, and optionally the metals include iron, copper, steel, and alloy.
27. The method of any one of embodiments 21-26, wherein the method removes iron.
28. A method of making the composition of any one of embodiments 1-20, wherein the method includes adding each component of the composition sequentially or adding all components of the composition at the same time to a container and mixing.
29. A method of making the composition of any one of embodiments 1-20, wherein the method comprises adding each component of the composition sequentially with constant mixing.

### EXAMPLES

Representative embodiments of the present invention will now be described with reference to the following examples that illustrate the principles and practice of the present invention.

### Example 1: Preparations of the Compositions

Compositions for cleaning wheels and tires were prepared using the formulations in Tables 1, 2, and 3. The components are added sequentially or all at the same time to a container and mixed. The compositions can be dispensed and stored in trigger sprayer bottles.

TABLE 1

| COMPONENTS | Wt. % | FUNCTION |
|---|---|---|
| DI or RO Water | 55 to 75 | Solvent |
| Benzisothiazolinone | 0.01 to 1.0 | Antimicrobial |
| Tetrasodium | 0.1 to 5.0 | Chelating |
| ethylenediamine | | agent |
| tetraacetate | | |
| Ammonium | 5 to 25 | Iron Remover |
| Thioglycolate | | |
| Diethylene | 5 to 15 | Cleaner |
| glycol monobutyl ether | | Enhancer |
| Cocamidopropyl | 1 to 10 | Cleaner |
| Betaine | | |
| Sodium C14-16 Olefin | 1 to 10 | Cleaner |
| Sulfonate | | |

TABLE 2

| | CONCENTRATION | | |
|---|---|---|---|
| | % of RAW | | |
| COMPONENTS | MATERIAL | Wt. % | FUNCTION |
| DI or RO Water | 100% | 55 to 75 | Solvent |
| Benzisothiazolinone | −10.76 (Mixture) | 0.01 to 1.0 | Antimicrobial |
| Tetrasodium | 39% | 0.1 to 5.0 | Chelating |
| ethylenediamine | | | agent |
| tetraacetate | | | |
| Ammonium | 60% | 5 to 25 | Iron Remover |
| Thioglycolate (ca. | | | |
| 60% in Water) | | | |
| Diethylene glycol | 100% | 5 to 15 | Cleaner |
| monobutyl ether | | | Enhancer |
| Cocamidopropyl | 30% | 1 to 10 | Cleaner |
| Betaine | | | |
| Sodium C14-16 | 40% | 1 to 10 | Cleaner |
| Olefin Sulfonate | | | |

TABLE 3

| TRADE | | CONCENTRATION % | | |
|---|---|---|---|---|
| NAME | COMPONENTS | of RAW MATERIAL | Wt. % | Function |
| DIW | Westlake DI/RO | 100% | 65.9 | Solvent |
| | Water | | | |
| Troygard | Benzisothiazol- | −10.76 (Mixture) | 0.1 | Antimicrobial |
| BC11 | 3(2h)-one, | | | |
| | 5-chloro-2- | | | |
| | methyl-4- | | | |
| | isothiazolin-3- | | | |
| | one, | | | |
| | 2-methyl-2H- | | | |
| | isothiazol-3-one | | | |
| | (Mixture) | | | |
| Versene 100 | Tetrasodium | 39% | 0.5 | Chelating |
| EDTA | ethylenediamine | | | agent |
| | tetraacetate | | | |
| Ammonium | Ammonium | 60% | 13.5 | Iron |
| Thioglycolate | Thioglycolate | | | Remover |
| | (ca. 60% in | | | |
| | Water) | | | |
| Butyl Carbitol | Diethylene glycol | 100% | 10 | Cleaner |
| | monobutyl ether | | | Enhancer |
| Caltaine C- | Cocamidopropyl | 30% | 5 | Cleaner |
| 35 | Betaine | | | |
| Calsoft AOS- | Sodium C14-16 | 40% | 5 | Cleaner |
| 40 | Olefin Sulfonate | | | |

### Example 2: Exemplary Methods of Using the Compositions

The compositions described herein can be used to clean the wheels (and tires). The compositions should not be used in direct sunlight and on wheels or painted surfaces that are warm to the touch, or on damaged wheels or painted surfaces. Before use, test the composition on an inconspicuous area, and if hazing appears, discontinue use. The compositions should be used outside in a well-ventilated space. The formula has a strong scent.

Example 2A: Wheel and Tire Cleaning: 1. Shake well the bottle containing the composition. 2. Hold the bottle 6 inches from the wheel or tire, then completely saturate the wheel or tire with the composition. 3. Leave the composition on the wheel or tire for about 2 to 4 minutes. 4. Color change indicates and reveals the dissolution of the brake dust contaminants. 5. Using a wheel and tire brush, thoroughly scrub the wheel and tire. 6. Do not allow the composition to dry on the vehicle surface. 7. Thoroughly rinse the wheel and tire. 8. For best results, dry with a soft, clean towel to prevent water spots. Repeat if necessary.

Example 2B: Cleaning Painted Vehicular Surfaces: 1. Wash and towel dry first the surface. Clean one surface at a time. 2. Shake well the bottle containing the composition. 3. Hold the bottle 6 inches from the surface, then spray all over the surface. 4. Leave the composition on the surface for about 2 to 4 minutes. 5. Color changing indicates and reveals the dissolution of the iron contaminants. 6. Do not allow the composition to dry on the surface. 7. Thoroughly rinse the vehicle's surface. 8. For best results, dry with a soft, clean towel to prevent water spots. Repeat if necessary.

1. A composition comprising:
one or more metal removers;
one or more cleaner enhancers; and
one or more cleaners
wherein the composition changes color when applied to a surface to remove one or more metals, and optionally wherein the one or more metals comprise iron.

2. The composition of claim 1, wherein the composition further comprises one or more chelating agents.

3. The composition of claim 1, wherein the composition further comprises one or more antimicrobial agents, and optionally, wherein the one or more antimicrobials comprise preservatives.

4. The composition of claim 1, wherein the composition further comprises one or more solvents.

5. The composition of claim 1, wherein the one or more metal removers comprise a catalyst, and optionally, wherein the catalyst comprises ammonium thioglycolate.

6. The composition of claim 5, wherein the one or more cleaners comprise one or more surfactants, and optionally, wherein the one or more surfactants comprise one or more anionic surfactants or amphoteric surfactants.

7. The composition of claim 6, wherein the one or more surfactants comprise betaines and metal olefin sulfonates, and optionally, wherein the betaines comprise cocamidopropyl betaine, and/or wherein the metal olefin sulfonates comprise sodium C14-16 olefin sulfonate.

8. The composition of claim 7, wherein the one or more cleaner enhancers comprise an organic solvent, and optionally, wherein the organic solvent comprises diethylene glycol monobutyl ether.

9. The composition of claim 1, wherein the composition further comprises one or more solvents, one or more antimicrobial agents, and one or more chelating agents, and optionally wherein the solvent comprises deionized (DI) and/or reverse osmosis (RO) water, wherein the one or more chelating agents comprise tetrasodium ethylenediamine tetraacetate, and/or wherein the one or more antimicrobial agents comprise benzisothiazolinone.

10. The composition of claim 9, wherein the composition comprises by weight percent (wt %) of the total composition:
about 55 wt % to about 75 wt % of water or DI and/or RO water;
about 0.01 wt % to about 1.0 wt % of benzisothiazolinone;
about 0.1 wt % to about 5.0 wt % of tetrasodium ethylenediamine tetraacetate;
about 5 wt % to about 25 wt % of ammonium thioglycolate;
about 5 wt % to about 15 wt % of diethylene glycol monobutyl ether;
about 1 wt % to about 10 wt % of cocamidopropyl betaine; and
about 1 wt % to about 10 wt % of sodium C14-16 olefin sulfonate.

11. The composition of claim 10, wherein the composition comprises by weight percent (wt %) of the total composition:
about 65.9 wt % of water or DI and/or RO water;
about 0.1 wt % of benzisothiazolinone;
about 0.5 wt % of tetrasodium ethylenediamine tetraacetate;
about 13.5 wt % of ammonium thioglycolate (ca. 60% in water);
about 10 wt % of diethylene glycol monobutyl ether;
about 5 wt % of cocamidopropyl betaine; and
about 5 wt % of sodium C14-16 olefin sulfonate.

12. A method of cleaning a surface, wherein the method comprises applying the composition of claim 1 to a surface, allowing the composition to remain on the surface until the color of the composition changes, and wiping the surface.

13. The method of claim 12, wherein the method further comprises rinsing the surface and/or drying the surface.

14. The method of claim 13, wherein the surface comprises the surface of a wheel or tire.

15. The method of claim 14, wherein the surface comprises a painted surface of a vehicle.

16. A method of cleaning a surface, wherein the method comprises applying the composition of claim 10 to a surface, allowing the composition to remain on the surface until the color of the composition changes, and wiping the surface.

17. The method of claim 16, wherein the method further comprises rinsing the surface and/or drying the surface.

18. The method of claim 17, wherein the surface comprises the surface of a wheel or tire.

19. The method of claim 18, wherein the surface comprises a painted surface of a vehicle.

20. A method of making the composition of claim 9, wherein the method comprises adding each component of the composition sequentially or adding all components of the composition at the same time to a container and mixing.
